(19) United States
(12) Patent Application Publication
(10) Pub. No.: US 2025/0018881 A1
(43) Pub. Date: Jan. 16, 2025

(54) WIPER FLUID RUNOFF COLLECTING APPARATUS

(71) Applicant: Dan Tetelbaun, Thornhill (CA)

(72) Inventor: Dan Tetelbaun, Thornhill (CA)

(21) Appl. No.: 18/221,228

(22) Filed: Jul. 12, 2023

(51) Int. Cl. B60R 13/07

(52) U.S. Cl. CPC B60R 13/07

(57) ABSTRACT

A wiper fluid runoff collecting apparatus for collecting wiper fluid which flows downwardly from a rear windshield of an automobile to protect the automobile from unsightly effects from the wiper fluid includes a container which mounts to a hatch of an automobile. A ramp is coupled to the container and abuts the rear windshield when the container is mounted to the hatch to direct wiper fluid from the rear windshield into the container. The ramp also acts as a barrier which keeps the wiper fluid contained in the container when the hatch is lifted and tilts the container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fluid collection apparatuses and more particularly pertains to a new fluid collection apparatus for collecting wiper fluid which flows downwardly from a rear windshield of an automobile to protect the automobile from unsightly effects from the wiper fluid.

### (2) Description of Related Art Including Information Disclosed Under 37 CFR 1.97 and 1.98

Wiper fluid has been known to cause unsightly streaks and discoloration of paint of automobiles. This is particularly a problem for rear sections of automobiles, which typically abut the rear windshield of the automobile such that wiper fluid runs off of the rear windshield directly onto the painted surface of the rear section of the automobile. The prior art discloses fluid collection or drainage apparatuses for vehicles. U.S. Pat. App. No. 2019/0366948, for example, discloses a gutter which mounts to a rear of a vehicle to catch runoff of wiper fluid below the rear windshield. However, the prior art fails to describe such an apparatus which maintains the wiper fluid within a container below the rear windshield when the hatch of the automobile is lifted. More particularly, the prior art does not describe the use of a ramp which directs wiper fluid into such a container and which is positioned to maintain the wiper fluid within the container when the hatch is pivoted upwardly, thus rotating the container.

### BRIEF SUMMARY OF THE INVENTION

An embodiment of the disclosure meets the needs presented above by generally comprising a container with a base wall and a perimeter wall. The perimeter wall is coupled to and extends away from the base wall. The perimeter wall and the base wall define a reservoir within the container, and a distal edge of the perimeter wall defines an opening to the reservoir. The perimeter wall has a front portion, a rear portion, and a pair of end portions. Each of the front portion and the rear portion is coupled to and extends between the pair of end portions. The container is elongated between the pair of end portions of the perimeter wall. The opening faces upwardly when the container is positioned in a collection position.

A ramp is coupled to the distal edge of the perimeter wall on the rear portion of the perimeter wall. The ramp is angled to extend downwardly from a rear edge of the ramp to a front edge of the ramp when the container is positioned in the collection position such that the ramp extends through the opening into the reservoir. The front edge of the ramp is spaced from the front portion of the perimeter wall, and the ramp is configured to guide wiper fluid into the reservoir when the container is positioned in the collection position and the wiper fluid is positioned on the ramp. The ramp is configured to retain the wiper fluid in the reservoir when the container is positioned in a tilted position wherein the front portion of the perimeter wall is positioned above the rear portion of the perimeter wall. A mount is coupled to the container and is configured to attach to an outer surface of a hatch of an automobile.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top rear side perspective view of a wiper fluid runoff collecting apparatus according to an embodiment of the disclosure.

FIG. 2 is a top front side perspective view of an embodiment of the disclosure.

FIG. 3 is a cross-section view of an embodiment of the disclosure taken from Arrows 3-3 in FIG. 1.

FIG. 4 is a detail view of a transparent portion of an embodiment of the disclosure.

FIG. 5 is a perspective view of a portion of a mount of an embodiment of the disclosure.

FIG. 6 is a perspective in-use view of an embodiment of the disclosure with a container shown in a collection position.

FIG. 7 is a side in-use view of an embodiment of the disclosure with the container shown in a tilted position.

### DETAILED DESCRIPTION OF THE INVENTION

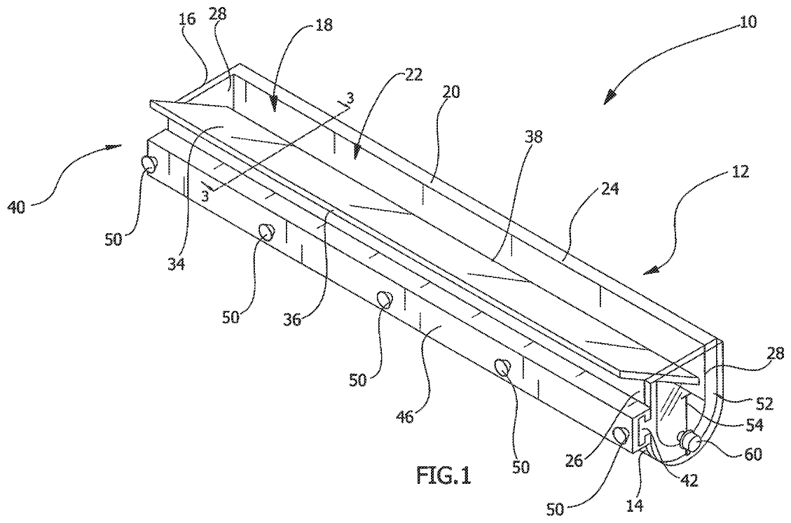

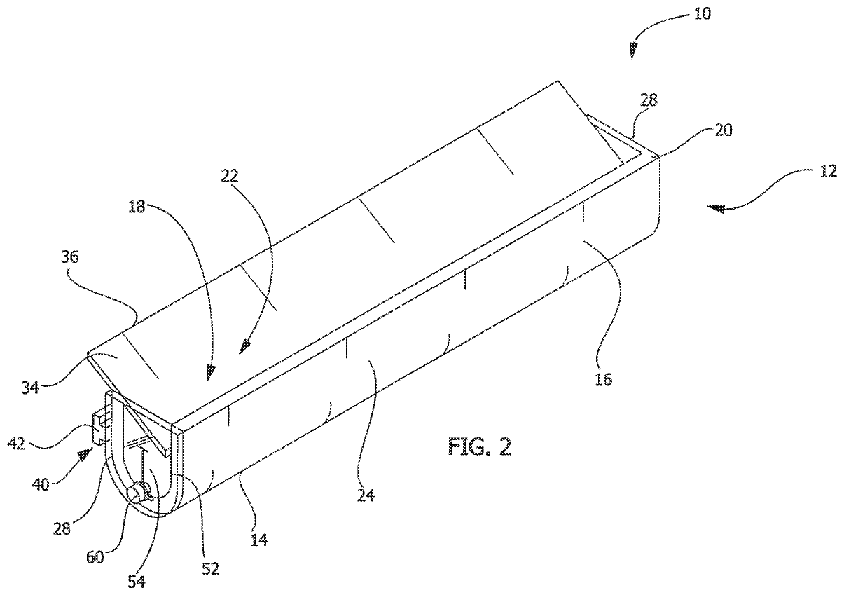

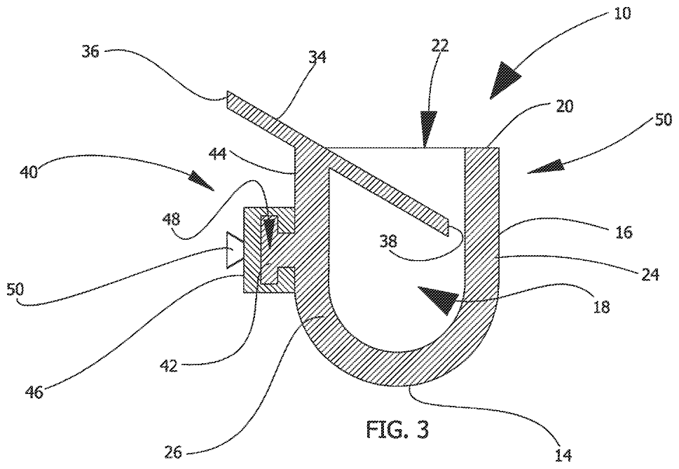

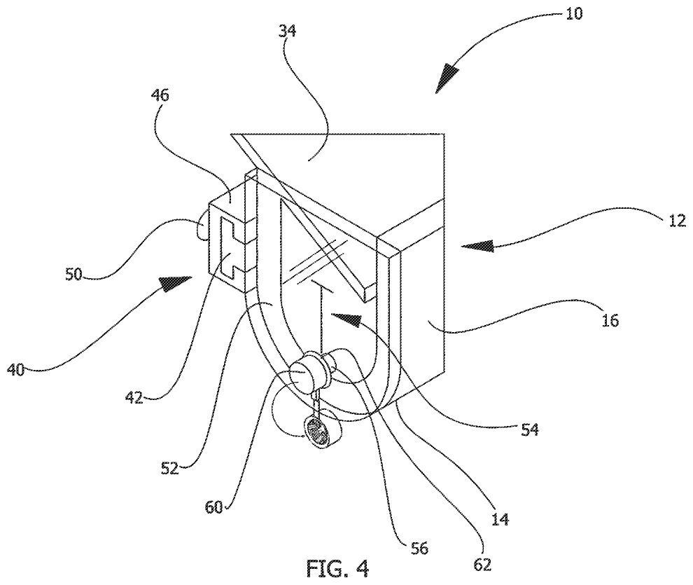

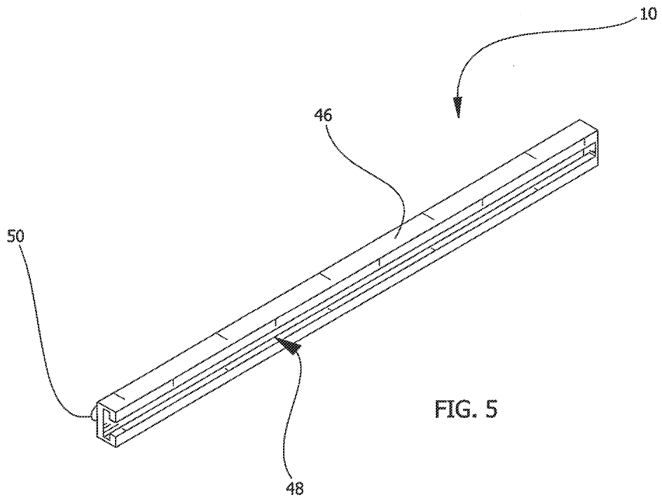

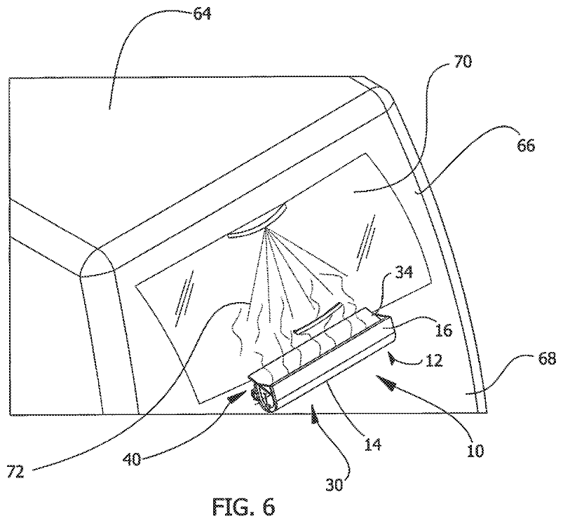

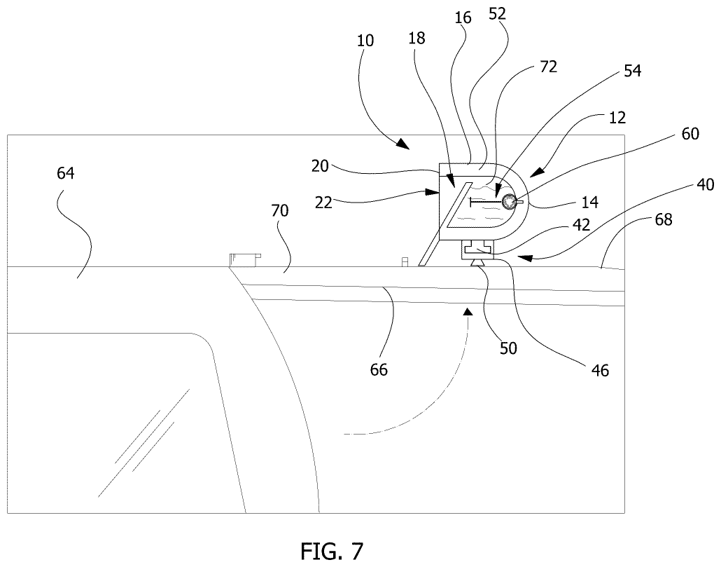

With reference now to the drawings, and in particular to FIGS. 1 through 7 thereof, a new fluid collection apparatus embodying the principles and concepts of an embodiment of the disclosure and generally designated by the reference numeral 10 will be described.

As best illustrated in FIGS. 1 through 7, the wiper fluid runoff collecting apparatus 10 generally comprises a container 12 with a base wall 14 and a perimeter wall 16. The perimeter wall 16 is coupled to and extends away from the base wall 14. The perimeter wall 16 and the base wall 14 define a reservoir 18 within the container 12, and a distal edge 20 of the perimeter wall 16 defines an opening 22 to the reservoir 18. The perimeter wall 16 has a front portion 24, a rear portion 26, and a pair of end portions 28. Each of the front portion 24 and the rear portion 26 is coupled to and extends between the pair of end portions 28. The container 12 is elongated between the pair of end portions 28 of the perimeter wall 16, and the opening 22 faces upwardly when the container 12 is positioned in a collection position 30.

A ramp 34 is coupled to the distal edge 20 of the perimeter wall 16 on the rear portion 26 of the perimeter wall 16. The ramp 34 is angled to extend downwardly from a rear edge 36 of the ramp 34 to a front edge 38 of the ramp 34 when the container 12 is positioned in the collection position 30 such that the ramp 34 extends through the opening 22 into the reservoir 18. The front edge 38 of the ramp 34 is spaced from the front portion 24 of the perimeter wall 16. The ramp 34 is configured to guide wiper fluid 72 into the reservoir 18 when the container 12 is positioned in the collection position 30 and the wiper fluid 72 is positioned on the ramp 34. The ramp 34 is also configured to retain the wiper fluid 72 in the reservoir 18 when the container 12 is positioned in a tilted position 32 wherein the front portion 24 of the perimeter wall 16 is positioned above the rear portion 26 of the perimeter wall 16.

A mount 40 is coupled to the container 12 and is configured to attach to an outer surface 68 of a hatch 66 of an automobile 64. The mount 40 comprises a slider member 42, a track 46, and a plurality of suction cups 50. The slider member 42 is coupled to an exterior side 44 of the rear portion 26 of the perimeter wall 16 and extends between the pair of end portions 28 of the perimeter wall 16. The track 46 is releasably couplable with the slider member 42 such that the slider member 42 is slidable along the track 46. The slider member 42 has a T-shaped cross section taken perpendicularly to a longitudinal axis of the container 12. The track 46 defines a slot 48 which is complementary in shape to the slider member 42. The plurality of suction cups 50 is coupled to the track 46 opposite the slot 48. The plurality of suction cups 50 may attach the mount 40 to the outer surface 68 of the hatch 66. The mount 40 also may comprise a magnet, a threaded fastener, or like fastening means. In some embodiments, the container 12 may be integrally formed with the hatch 66.

The rear edge 36 of the ramp 34 is positioned relative to the mount 40 such that the rear edge 36 is configured to abut a rear windshield 70 of the hatch 66 of the automobile 64 when the mount 40 is attached to the hatch 66. The ramp 34 comprises a flexible material such that the ramp 34 conforms to the rear windshield 70 when the ramp 34 abuts the windshield. One of the pair of end portions 28 of the perimeter wall 16 defines a transparent portion 52 which is transparent such that the transparent portion 52 facilitates viewing the reservoir 18 through the transparent portion 52. An indicia 54 is coupled to the transparent portion 52 of the perimeter wall 16 and is positioned such that the indicia 54 is configured to indicate an amount 40 of the wiper fluid 72 in the reservoir 18 which would spill over the ramp 34 if the container 12 was positioned in the tilted position 32. The indicia 54 may, for example, include a line segment which lies horizontally when the container 12 is positioned in the collection position 30. The line segment would align with a level of a top surface of the wiper fluid 72 when the container 12 contains a maximum volume of wiper fluid 72 which will not spill over the ramp 34 when the container 12 is positioned in the tilted position 32.

A drain tube 56 extends through the container 12 and is in fluid communication with the reservoir 18. The drain tube 56 is positioned on the perimeter wall 16 adjacent to a bottom 58 of the reservoir 18. A cap 60 is removably attached to an outer end 62 of the drain tube 56 with respect to the container 12.

In use, the wiper fluid runoff collecting apparatus 10 is attached to the outer surface 68 of the hatch 66 of the automobile 64 such that the rear edge 36 of the ramp 34 abuts the rear windshield 70. When wiper fluid 72 is dispensed onto the rear windshield 70 and falls onto the ramp 34, the ramp 34 directs the wiper fluid 72 into the reservoir 18. The amount 40 of the wiper fluid 72 contained in the reservoir 18 is viewable through the transparent portion 52 of the container 12. The wiper fluid 72 may be drained through the drain tube 56 by removing the cap 60 from the drain tube 56, thus draining the wiper fluid 72 away from the automobile 64 and not tarnishing the automobile 64.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wiper fluid runoff collecting apparatus comprising:
a container having a base wall and a perimeter wall, the perimeter wall being coupled to and extending away from the base wall, the perimeter wall and the base wall defining a reservoir within the container, a distal edge of the perimeter wall defining an opening to the reservoir, the perimeter wall having a front portion, a rear portion, and a pair of end portions, each of the front portion and the rear portion being coupled to and extending between the pair of end portions, the container being elongated between the pair of end portions of the perimeter wall, the opening facing upwardly when the container is positioned in a collection position;
a ramp being coupled to the distal edge of the perimeter wall on the rear portion of the perimeter wall, the ramp being angled to extend downwardly from a rear edge of the ramp to a front edge of the ramp when the container is positioned in the collection position such that the ramp extends through the opening into the reservoir, the front edge of the ramp being spaced from the front portion of the perimeter wall, the ramp being configured to guide wiper fluid into the reservoir when the container is positioned in the collection position and the wiper fluid is positioned on the ramp, the ramp being configured to retain the wiper fluid in the reservoir when the container is positioned in a tilted position wherein the front portion of the perimeter wall is positioned above the rear portion of the perimeter wall; and
a mount being coupled to the container, the mount being configured to attach to an outer surface of a hatch of an automobile.

2. The apparatus of claim 1, wherein the mount comprises:
a slider member being coupled to an exterior side of the rear portion of the perimeter wall; and
a track being releasably couplable with the slider member such that the slider member is slidable along the track.

3. The apparatus of claim 2, wherein the track defines a slot, the slot being complementary in shape to the slider member.

4. The apparatus of claim 3, wherein the slider member extends between the pair of end portions of the perimeter wall, the slider member having a T-shaped cross section taken perpendicularly to a longitudinal axis of the container.

5. The apparatus of claim 2, wherein the mount further comprises a plurality of suction cups being coupled to the track opposite the slot, the plurality of suction cups being configured to attach the mount to the outer surface of the hatch of the automobile.

6. The apparatus of claim 1, wherein the rear edge of the ramp is positioned relative to the mount such that the rear edge is configured to abut a rear windshield of the hatch of the automobile when the mount is attached to the hatch.

7. The apparatus of claim 1, wherein the ramp comprises a flexible material such that the ramp conforms to the rear windshield when the ramp abuts the windshield.

8. The apparatus of claim 1, wherein one of the pair of end portions of the perimeter wall defines a transparent portion which is transparent such that the transparent portion facilitates viewing the reservoir through the transparent portion.

9. The apparatus of claim 8, further comprising an indicia being coupled to the transparent portion of the perimeter wall, the indicia being positioned such that the indicia is configured to indicate an amount of the wiper fluid in the reservoir which would spill over the ramp if the container was positioned in the tilted position.

10. The apparatus of claim 1, further comprising:
a drain tube extending through the container and being in fluid communication with the reservoir; and
a cap being removably attached to an outer end of the drain tube with respect to the container.

11. A wiper fluid runoff collecting apparatus comprising:
a container having a base wall and a perimeter wall, the perimeter wall being coupled to and extending away from the base wall, the perimeter wall and the base wall defining a reservoir within the container, a distal edge of the perimeter wall defining an opening to the reservoir, the perimeter wall having a front portion, a rear portion, and a pair of end portions, each of the front portion and the rear portion being coupled to and extending between the pair of end portions, the container being elongated between the pair of end portions of the perimeter wall, the opening facing upwardly when the container is positioned in a collection position;
a ramp being coupled to the distal edge of the perimeter wall on the rear portion of the perimeter wall, the ramp being angled to extend downwardly from a rear edge of the ramp to a front edge of the ramp when the container is positioned in the collection position such that the ramp extends through the opening into the reservoir, the front edge of the ramp being spaced from the front portion of the perimeter wall, the ramp being configured to guide wiper fluid into the reservoir when the container is positioned in the collection position and the wiper fluid is positioned on the ramp, the ramp being configured to retain the wiper fluid in the reservoir when the container is positioned in a tilted position wherein the front portion of the perimeter wall is positioned above the rear portion of the perimeter wall;
a mount being coupled to the container, the mount comprising:
a slider member being coupled to an exterior side of the rear portion of the perimeter wall, the slider member extending between the pair of end portions of the perimeter wall, the slider member having a T-shaped cross section taken perpendicularly to a longitudinal axis of the container;
a track being releasably couplable with the slider member such that the slider member is slidable along the track, the track defining a slot, the slot being complementary in shape to the slider member; and
a plurality of suction cups being coupled to the track opposite the slot, the plurality of suction cups being configured to attach the mount to an outer surface of a hatch of an automobile;
wherein the rear edge of the ramp is positioned relative to the mount such that the rear edge is configured to abut a rear windshield of the hatch of the automobile when the mount is attached to the hatch, the ramp comprising a flexible material such that the ramp conforms to the rear windshield when the ramp abuts the windshield;
wherein one of the pair of end portions of the perimeter wall defines a transparent portion which is transparent such that the transparent portion facilitates viewing the reservoir through the transparent portion;
an indicia being coupled to the transparent portion of the perimeter wall, the indicia being positioned such that the indicia is configured to indicate an amount of the wiper fluid in the reservoir which would spill over the ramp if the container was positioned in the tilted position;
a drain tube extending through the container and being in fluid communication with the reservoir, the drain tube being positioned on the perimeter wall adjacent to a bottom of the reservoir; and
a cap being removably attached to an outer end of the drain tube with respect to the container.
